(19) United States
(12) Patent Application Publication
(10) Pub. No.: US 2026/0256142 A1
(43) Pub. Date: Sep. 3, 2026

(54) FUNGICIDE COMPOSITION

(71) Applicant: UPL LIMITED, Maharashtra Mumbai (IN)

(72) Inventors: Sujata Dhondiram DESAI, Mumbai (IN); Samadhan PATIL, Mumbai (IN)

(21) Appl. No.: 18/881,580

(22) PCT Filed: Dec. 26, 2022
(86) PCT No.: PCT/IB2022/062783

§ 371 Date: Jan. 6, 2025

(30) Foreign Application Priority Data
Jul. 4, 2022 (IN) 202221038377

(51) Int. Cl. A01N 43/40; A01N 25/02; A01N 25/10; A01N 43/54; A01N 43/653; A01P 3/00

(52) U.S. Cl. CPC A01N 43/40; A01N 25/02; A01N 25/10; A01N 43/54; A01N 43/653; A01P 3/00

(57) ABSTRACT

The present invention relates to a stable agrochemical composition comprising a succinate dehydrogenase inhibitor (SDHI) fungicide and other fungicidally active compounds thereof. The present invention further relates to a process for preparing a stable agrochemical composition, and a method for controlling pests using the stable agrochemical composition.

### FIELD OF THE INVENTION

The present invention relates to a stable agrochemical composition comprising a succinate dehydrogenase inhibitor (SDHI) fungicide and other fungicidally active compounds and use thereof. The present invention also relates to a process of preparing the stable agrochemical composition and a method of controlling pests using the agrochemical composition.

### BACKGROUND OF THE INVENTION

Practical agricultural experience has shown that the repeated and exclusive application of an individual active compound in the control of harmful fungi leads to natural or adapted resistance. To reduce the risk of selection of resistant fungus strains, mixtures of different active compounds are nowadays conventionally employed for controlling harmful fungi. By combining two or three active compounds having each different mechanisms of action, it is possible to ensure successful fungi control over a relatively long period of time.

The SDHI (succinate dehydrogenase inhibitor) fungicides belong to FRAC group 7 which acts by inhibiting complex II of the fungal mitochondrial respiration by binding and blocking SDH-mediated electron transfer from succinate to ubiquinone.

Boscalid is a fungicide known to be a succinate dehydrogenase inhibitor (SDHI) fungicide. It is a fungicide with translaminar and acropetal movement within the plant leaf, providing preventive and in some cases, curative action. It inhibits spore germination, germ tube elongation and is also effective on all other stages of fungal development.

In order to widen the spectrum of activity as well as to enhance the effectiveness of fungicidal control, it is a common practice to combine succinate dehydrogenase Inhibitor such as boscalid with additional fungicidal active ingredients of other class and such important classes of fungicide include conazole fungicides and strobilurin fungicides.

With a view of overcoming resistance as well as to impart broad spectrum coverage, when a composition comprising boscalid with either strobilurins fungicides, such as azoxystrobin or triazole fungicides, such as prothioconazole or tebuconazole, formulators need to handle critical formulation challenges in terms of choice of formulation type, stability of active ingredients as well as performance in terms of application for pest control.

When different active ingredients are combined for the purpose of broad spectrum of control, diverse chemical profile of individual active ingredients pose challenges, and it has often been found that formulation for example the granules are not easily dispersible in water. On the other hand, agglomerates which are readily water-dispersible are often not sufficiently resistant to attrition and form a fine dust fraction upon handling and shipping. If conventional binders are added to make the granules strong, then they are not dispersible in water. When WDGs meant for high loading of active ingredients, suspensibility becomes the real challenge. High loading granules may not rapidly or completely water dispersible and are not suitable for use in preparing sprayable suspensions. WDGs with good suspensibility demonstrate that a sufficient amount of the active substance is suspended in spray liquid to produce a satisfactory, homogeneous mixture during spraying.

Therefore, there is a need to develop an effective fungicide composition comprising boscalid and another active ingredient in a granular form, especially in the form of water dispersible granules (WDG). The granular composition of boscalid with other active ingredient is stable having higher suspensibility of active ingredients and can be used as broad-spectrum fungicides.

### OBJECTIVES OF THE PRESENT INVENTION

An object of the present invention is to provide a stable agrochemical composition comprising succinate dehydrogenase inhibitor (SDHI) fungicide and additional fungicidally active ingredient.

Another object of the present invention is to provide water dispersible granules comprising SDHI fungicide and additional fungicidally active ingredients.

Another object of the present invention is to provide water dispersible granules comprising SDHI fungicide and additional fungicidally active ingredients with improved suspensibility and greater dispersibility.

Still another objective of the present invention is to provide a method of controlling pests using a stable agrochemical composition comprising SDHI fungicide and additional fungicidally active ingredients.

It is an object to provide methods and compositions that result in an improvement in the health of crop plants which are susceptible to infection by phytopathogenic fungi and fungus-like pathogens.

### SUMMARY OF THE INVENTION

In an aspect of the present invention, an agrochemical composition comprises:
(i) at least one succinate dehydrogenase inhibitor fungicide;
(ii) an additional fungicide;
(iii) a linear alcohol derivative; and
(iv) a polymeric dispersant.

In an aspect of the present invention, a stable agrochemical composition comprises:
(i) at least one succinate dehydrogenase inhibitor fungicide;
(ii) an additional fungicide;
(iii) a linear (C₈-C₁₅) alcohol derivative; and
(iv) a styrene acrylic acid co-polymer.

In another aspect of the present invention, an agrochemical composition comprises:
(i) at least one succinate dehydrogenase inhibitor fungicide;
(ii) an additional fungicide;
(iii) a linear (C₈-C₁₅) alcohol derivative; and
(iv) a styrene acrylic acid co-polymer;
   wherein the linear alcohol derivative and the styrene acrylic copolymer are present in a ratio from about 0.5:1 to about 0.5:3.

In another aspect of the present invention, there is provided use of the agrochemical composition for controlling undesired fungal pests and diseases.

In another aspect of the present invention, there is provided a process of preparing an agrochemical composition comprising: (a) at least one succinate dehydrogenase inhibitor fungicide, (b) an additional fungicide; c) a linear alcohol derivative; and d) a polymeric dispersant.

In another aspect of the present invention, there is provided a method of controlling fungal diseases by applying to the plants or to their locus, an agrochemical composition comprising: (a) at least one succinate dehydrogenase inhibitor fungicide; (b) an additional fungicide; (c) a linear (C₈-C₁₅) alcohol derivative; and (d) polymeric dispersant.

### BRIEF DESCRIPTION OF DRAWING

FIG. 1: Rice crop with sheath blight after treatment with the agrochemical composition at dose rates of 625 g/Ha, 750 g/Ha and 1000 g/Ha.

FIG. 2: Rice crop with blast disease after treatment with the agrochemical composition at dose rate of 1000 g/Ha.

### DETAILED DESCRIPTION OF THE INVENTION

The following description is provided to assist in a comprehensive understanding of exemplary embodiments of the invention. It includes various specific details to assist in that understanding but these are to be regarded as merely exemplary.

The terms used in the following description and claims are not limited to the bibliographical meanings but are merely used by the inventor to enable a clear and consistent understanding of the invention. For the purposes of the present disclosure, it is to be understood that the invention may assume various alternative variations and step sequences, except where expressly specified to the contrary. Unless defined otherwise, all technical and scientific terms used herein have the same meaning as commonly understood by one of ordinary skill in the art to which this invention belongs. It must be noted that, as used in this specification, the singular forms “a,” “an” and “the” include plural referents unless the content clearly dictates otherwise.

As used herein, the terms “comprising” “including,” “having,” “containing,” “involving,” and the like are to be understood to be open-ended, i.e., to mean including but not limited to. The terms “preferred” and “preferably” refer to embodiments of the invention that may afford certain benefits, under certain circumstances. The aspects and embodiments described herein shall also be interpreted to replace the clause “comprising” with either “consisting of” or with “consisting essentially of” or with “consisting substantially of”.

Moreover, other than in any operating examples, or where otherwise indicated, all numbers expressing, for example, quantities of materials/ingredients used in the specification are to be understood as being modified in all instances by the term “about”. The term “about” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10 or ±5 of the stated value. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. It is understood that where a parameter range is provided, all integers within that range, and tenths thereof, are also provided. For example, “0.1-80%” includes 0.1%, 0.15, 0.2%, 0.25, 0.3% . . . etc. up to 80%.

As used herein the term “% w/w” or % means percentage by weight, relative to the weight of the total composition.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed.

The term “Alkyl” means a straight or branched chain saturated aliphatic hydrocarbon having the specified number of carbon atoms, specifically 1 to 12 carbon atoms, more specifically 1 to 6 carbon atoms. Alkyl groups include, for example, groups having from 1 to 50 carbon atoms (C₁ to C₅₀ alkyl). The term “Aryl” means a cyclic moiety in which all ring members are carbon and at least one ring is aromatic, the moiety having the specified number of carbon atoms, specifically 6 to 24 carbon atoms, more specifically 6 to 12 carbon atoms. More than one ring may be present, and any additional rings may be independently aromatic, saturated or partially unsaturated, and may be fused, pendant, spirocyclic or a combination thereof.

As used herein the term “plant” or “crop” refers to whole plants, plant organs (e.g., leaves, stems, twigs, roots, trunks, limbs, shoots, fruits etc.), plant cells, or plant seeds. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

The term “locus” as used herein denotes the vicinity or area designated for growth of a desired crop.

To “control” or “controlling” fungus means to inhibit, and/or supress the ability of target fungus or a fungus-like pathogen to grow and/or reproduce, or to limit fungus- and fungus-like pathogen-related damage or loss in crop plants or denotes control and prevention of a disease.

The term “agrochemically effective amount” is that quantity of active agent, applied in any amount which will provide the required control of fungal pathogens and diseases. The amount of active used is dependent upon many factors including, for example, the crop, type of fungus and disease sought to be controlled and environmental conditions. The selection of the proper quantity of active agent to be applied, however, is within the expertise of one skilled in the art. Further, the term “active ingredient” used herein refers to that component of the composition responsible for control of fungus or fungal disease. The term “excipient” or “additive” or “carrier” can be used interchangeably.

The term “salts” referred to herein are agriculturally acceptable salts. As used herein, an “agriculturally acceptable salt” means a salt which is acceptable for use in agricultural or horticultural use.

The term ‘stable’ referred to herein refers to chemical and/or physical stabilization of the composition in terms of achieving chemical stability of the active ingredient and desired suspensibility and dispersibility of the composition by maintaining homogeneity of the components that impart shelf life upto 1 year or more than 2 years.

Surprisingly, it has been found by the present inventors that succinate dehydrogenase inhibitor, for example boscalid can be combined with various fungicidal active ingredients for example strobilurin and triazole class of fungicides in the WDG formulation using a finely balanced surfactant system comprising a linear alcohol derivative and a polymeric dispersant, such as styrene acrylic polymer in a ratio from 0.5:1 to 0.5:3. The diverse chemistry of linear (C₈-C₁₅) alcohol derivative and styrene acrylic polymer found to offer desired suspensibility boost to boscalid and additional fungicide active ingredients in WDG composition. Unexpectedly, the present inventors did not observe desired suspensibility when linear (C₈-C₁₅) alcohol derivative and styrene acrylic polymer were used alone in the composition. Also, the surfactant system couldn't demonstrate desired suspensibility level when the ratio of linear (C₈-C₁₅) alcohol derivative and styrene acrylic polymer were outside the stabilizing ratio range from 0.5:1 to 0.5:3. Therefore, surprising benefits were observed in terms of suspensibility and overall stability when boscalid is combined with additional active ingredients in the presence of a surfactant system comprising linear (C₈-C₁₅) alcohol derivative and styrene acrylic polymer in a ratio from 0.5:1 to 0.5:3.

Therefore, the object of the present invention is to provide stable WDG (water dispersible granule) formulation comprising a fungicide selected from class of SDHI (Succinate dehydrogenase inhibitor) and an additional fungicide.

Thus, the present invention relates to fungicidal mixtures comprising a succinate dehydrogenase inhibitor fungicide and an additional fungicide in a synergistically effective amount.

In an aspect the present invention provides, an agrochemical composition comprises:
(i) at least one succinate dehydrogenase inhibitor fungicide;
(ii) an additional fungicide;
(iii) a linear alcohol derivative; and
(iv) a polymeric dispersant.

According to an embodiment of the present invention, the stable agrochemical composition comprises:
(i) at least one succinate dehydrogenase inhibitor fungicide;
(ii) an additional fungicide;
(iii) a linear (C₈-C₁₅) alcohol derivative; and
(iv) a styrene acrylic acid co-polymer.

In an embodiment of the present invention the succinate dehydrogenase inhibitor fungicide is selected from the group of flutolanil, boscalid, isofetamid, fluxapyroxad and penthiopyrad, salts, esters, isomers, polymorphs or derivatives or mixtures thereof.

In an embodiment the succinate dehydrogenase inhibitor fungicide is boscalid salts, esters, isomers, polymorphs or derivatives thereof.

In an embodiment the succinate dehydrogenase inhibitor fungicide is fluoxapyroxad salts, esters, isomers, polymorphs or derivatives or mixtures thereof.

In an embodiment the present composition comprises from about 0.1% w/w to about 80% w/w succinate dehydrogenase inhibitor fungicide of the total weight of the composition.

In an embodiment the present composition comprises from about 0.5% w/w to about 60% w/w succinate dehydrogenase inhibitor fungicide of the total weight of the composition.

In an embodiment the present composition comprises from about 1% w/w to about 50% w/w succinate dehydrogenase inhibitor fungicide or a derivative thereof of the total weight of the composition.

In an embodiment the additional fungicide used in the present composition is selected from the group of dithiocarbamate, conazole, benzimidazole, strobilurin and copper group of fungicides, salts, esters, isomers, polymorphs or derivatives thereof.

In an embodiment the present composition comprises conazole fungicides selected from the group of azaconazole, bromuconazole, cyproconazole, diclobutrazol, difenoconazole, epoxiconazole, etaconazole, fenbuconazole, flusilazole, flutriafol, furconazole, hexaconazole, metconazole, myclobutanil, penconazole, propiconazole, prothioconazole, quinconazole, simeconazole, tebuconazole, tetraconazole, triticonazole and uniconazole and derivatives thereof.

In an embodiment the present composition comprises strobilurin fungicides selected from the group of azoxystrobin, fluoxastrobin, picoxystrobin, pyraoxystrobin, pyraclostrobin, pyrametostrobin, fenaminstrobin, metominostrobin, kresoxim-methyl and trifloxystrobin and derivatives thereof.

In an embodiment the present composition comprises from about 0.1% w/w to about 80% w/w of additional fungicide of the total weight of the composition.

In an embodiment the present composition comprises from about 0.5% w/w to about 60% w/w of additional fungicide of the total weight of the composition.

In an embodiment the present composition comprises from about 1% w/w to about 50% w/w of additional fungicide of the total weight of the composition.

In an embodiment, the present composition comprises a succinate dehydrogenase inhibitor fungicide and at least one additional fungicide wherein the weight ratio of succinate dehydrogenase inhibitor fungicide and at least one additional fungicide is in the range from about 1:100 to 100:1.

In an embodiment, the weight ratio of succinate dehydrogenase inhibitor fungicide and at least one additional fungicide is in the range from about 1:50 to 50:1.

In an embodiment the weight ratio of succinate dehydrogenase inhibitor fungicide and at least one additional fungicide is in the range from about 1:20 to 20:1.

In an embodiment the weight ratio of succinate dehydrogenase inhibitor fungicide and at least one additional fungicide is in the range from about 1:10 to 10:1.

In an embodiment the weight ratio of succinate dehydrogenase inhibitor fungicide and at least one additional fungicide is in the range from about 1:5 to 5:1.

In an embodiment the present composition comprises a linear alcohol derivative.

In an embodiment the present composition comprises a linear alkoxylated alcohol.

In an embodiment the present composition comprises a linear (C₈-C₁₅) alcohol derivative.

In an embodiment the present composition comprises a linear (C₈-C₁₅) alcohol derivative selected from the group consisting of linear C₈ alcohol derivative, linear C₉ alcohol derivative, linear C₁₀ alcohol derivative, linear C₁₁ alcohol derivative, linear C₁₂ alcohol derivative, linear C₁₃ alcohol derivative, linear C₁₄ alcohol derivative and linear C₁₅ alcohol derivative.

In an embodiment the present composition comprises a linear (C₈-C₁₅) alcohol derivative selected from the group comprising of linear C₁₀ alcohol derivative, linear C₁₁ alcohol derivative, linear C₁₂ alcohol derivative.

In an embodiment the present composition comprises a linear (C₈-C₁₅) alcohol derivative selected from the group consisting of sodium 2-ethyl hexyl sulphate, sodium decyl sulphate, sodium octyl sulphates, sodium lauryl sulphate, potassium salt of dodecyl sulphate, there salts and derivatives thereof.

In an embodiment the present composition comprises from about 0.01% w/w to about 20% w/w linear alcohol derivative of the total weight of the composition.

In an embodiment the present composition comprises from about 0.1% w/w to about 20% w/w linear alcohol derivative of the total weight of the composition.

In preferred embodiment the present composition comprises from about 0.5% w/w to about 20% w/w linear alcohol derivative of the total weight of the composition.

In an embodiment the present composition comprises of a polymeric dispersant.

In an embodiment the present composition comprises a polymeric dispersant selected from the group consisting of EO/PO block copolymers, styrene acrylic acid co-polymer, methacrylic copolymers, polyhydroxystearate derivatives and alkyl polyethylene (PEG) resin derivatives.

In an embodiment the polymeric dispersants are commercially available in marketed under various trade names as Atlox Metasperse™550S, Tersperse® 2700, Triton X-100, Poloxamers, Tergitol™, Antarox® and the like.

In an embodiment the present composition comprises a styrene acrylic acid co-polymer.

In an embodiment the present composition comprises a modified styrene acrylic acid co-polymer.

In an embodiment the present invention, the stable agrochemical composition comprises of sodium-neutralized styrene/acrylic acid copolymer.

In an embodiment the present composition comprises from about 0.01% w/w to about 20% w/w polymeric dispersant of the total weight of the composition.

In an embodiment the present composition comprises from about 0.1% w/w to about 20% w/w polymeric dispersant of the total weight of the composition.

In a preferred embodiment the present composition comprises from about 0.5% w/w to about 20% w/w polymeric dispersant of the total weight of the composition.

In an embodiment of the present invention, the linear alcohol derivative and polymeric dispersant are used in a ratio from about 0.5:1 to about 0.5:3.

In an embodiment of the present invention, the linear (C₈-C₁₅) alcohol derivative and styrene acrylic acid co-polymer are used in a ratio from about 0.5:1 to about 0.5:3.

In an embodiment of the present invention, the linear (C₈-C₁₅) alcohol derivative and styrene acrylic acid co-polymer are used in 0.5:1 ratio.

In an embodiment of the present invention, the linear (C₈-C₁₅) alcohol derivative and styrene acrylic acid co-polymer are used in 1:1 ratio.

In an embodiment of the present invention, the linear (C₈-C₁₅) alcohol derivative and styrene acrylic acid co-polymer are used in 1:1.5 ratio.

In an embodiment of the present invention, the linear (C₈-C₁₅) alcohol derivative and styrene acrylic acid co-polymer are used in 1:2 ratio.

In an embodiment of the present invention, the linear (C₈-C₁₅) alcohol derivative and styrene acrylic acid co-polymer are used in 1:2.5 ratio.

In an embodiment of the present invention, the linear (C₈-C₁₅) alcohol derivative and styrene acrylic acid co-polymer are used in 1:3 ratio.

In an embodiment the present compositions further comprise formulation excipients for example surfactants (emulsifier), crop oil, fertilizers, dispersing agents, compatibility agents, defoamers, antimicrobial agents, stabilizers, preservatives, antioxidants, correctives, spray colorants (dyes) and the like.

In an embodiment, the agriculturally acceptable excipient or additive or formulation excipients is any or a combination of a surfactant, chelating agents, stabilizers, a preservative, a colouring agent, a pH adjusting agent, inert carriers, anti-foaming agent and a solvent.

In an embodiment, the agriculturally acceptable excipients are present in an amount ranging from 0.1% to 99% by weight of the composition. The concentration of the agrochemically active agent ranges from 1% to 50% w/w of the total composition.

In an embodiment, the present agrochemical composition is formulated in the solid form which can comprise inactive ingredients or binders. A wide variety of binders can be used, like for example lactose powder, dibasic calcium phosphate, sucrose, corn (maize) starch, microcrystalline cellulose or modified cellulose, like for example hydroxymethyl cellulose.

The agrochemical composition may also contain an ingredient that can act as a disintegrant, which hydrates readily in water and thereby improves the dispersion of the composition in water. Some of the above-mentioned binders, like for example starch and cellulose, can also be used as a disintegrant.

Commonly used lubricants are for example magnesium stearate, stearic acid (stearine), hydrogenated oil and sodium stearyl fumarate.

The examples of inert carriers include ammonium sulphate, sucrose, lactose, mineral earths and clays such as bentonite, perlite, talc, kaolin, aluminum silicate, diatomaceous earth, attapulgite, clay, barium sulfate, mica, zeolites, calcium carbonate, fused sodium potassium, precipitated silica, precipitated silicates, aluminum silicate, sodium citrate, potassium citrate and magnesium citrate.

The wetting agent may include any or a combination of sulfosuccinates, naphthalene sulfonates, sulfated esters, phosphate esters, sulfated alcohol and alkyl benzene sulfonates, but not limited thereto.

The dispersing agent may include any or a combination of polycarboxylates, naphthalene sulfonate condensates, phenol sulfonic acid condensates, lignosulfonates, methyl oleyl taurates and polyvinyl alcohols, but not limited thereto.

The binding agent may include any or a combination of polyvinyl alcohols, phenyl naphthalene sulphonate, lignin derivatives, polyvinyl pyrrolidone, polyalkylpyrrolidone, carboxymethylcellulose, xanthan gum, polyethoxylated fatty acids, polyethoxylated fatty alcohols, ethylene oxide copolymer, propylene oxide copolymer, polyethylene glycols and polyethylene oxides, but not limited thereto.

The surfactant may include any or a combination of: ionic surfactants and non-ionic surfactants. Non-limiting examples of ionic surfactants include sulfonic acids, sulfuric acid esters, carboxylic acids, and salts thereof. Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyl oxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, and alkyl carboxylates. Non-limiting examples of the non-ionic surfactants include glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty esters, or combinations thereof.

The anti-freezing agents may include any or a combination of ethylene glycol, propylene glycol, urea, glycerine, and anti-freeze proteins, but not limited thereto.

The minerals may include any or a combination of kaolin, silica, titanium (IV) oxide, rutile, anatase, aluminium oxides, aluminium hydroxides, iron oxide, iron sulphide, magnetite, pyrite, hematite, ferrite, gregite, calcium carbonate, calcite, aragonite, quartz, zircon, olivine, orthopyroxene, tourmaline, kyanite, albite, anorthite, clinopyroxene, orthoclase, gypsum, andalusite, talc, fluorite, apatite, orthoclase, topaz, corundum, diamond, tin, tin oxides, antimony, antimony oxides, beryllium, cobalt, copper, feldspar, gallium, indium, lead, lithium, manganese, mica, molybdenum, nickel, perlite, platinum group metals, phosphorus and phosphate rock, potash, rare earth elements, tantalum, tungsten, vanadium, zeolites, zinc and zinc oxide, and indium tin oxide, but not limited thereto.

The fillers may include any or a combination of diatomaceous earth, kaolin, bentonite, precipitated silica, attapulgite, and perlite, but not limited thereto.

In an embodiment, the chelating agent comprises Ethylene diamine tetra acetic acid (EDTA) salts. In an embodiment the EDTA salt is Ethylene diamine tetra acetic acid, sodium salt and the like.

In an embodiment, the composition can further comprise at least one from the group of fertilizers, mycorrhiza, micronutrients, acaricides, algicides, antifeedants, avicides, bactericides, bird repellents, chemosterilants, fungicides, herbicide safeners, herbicides, insect attractants, insect repellents, insecticides, mammal repellents, mating disruptors, molluscicides, nematicides, plant activators, plant-growth regulators, rodenticides, synergists, virucides, derivatives thereof, biological control agents and mixtures thereof.

The advantageous agricultural compositions of the present disclosure can be formulated in any of formulations such as emulsifiable concentrate, wettable powder, soluble powder, suspension concentrate, spray concentrate, capsule suspension, water dispersible granule, granules, dusts, microgranule for seed treatment formulation.

According to an embodiment of the present invention, the stable agrochemical composition comprises: (a) at least one SDHI fungicide; (b) an additional fungicide or a derivative thereof; (c) a linear alcohol derivative; and (d) a polymeric dispersant wherein said composition is in the form of solid formulation.

According to an embodiment the present stable agrochemical composition is formulated in the form of water dispersible granules (WDG).

According to an embodiment of the present invention, the stable agrochemical composition comprises: (a) at least one succinate dehydrogenase inhibitor fungicide; (b) an additional fungicide or a derivative thereof; (c) a linear alcohol derivative; and (d) a polymeric dispersant wherein said composition is in the form of water dispersible granules (WDG).

According to an embodiment of the present invention, the stable agrochemical composition comprises: (a) at least one succinate dehydrogenase inhibitor fungicide; (b) an additional fungicide or a derivative thereof; (c) a linear alcohol derivative; and (d) a polymeric dispersant wherein said composition is in the form of wettable powder (WP).

In an embodiment the succinate dehydrogenase inhibitor fungicide is boscalid or salts, esters, isomers, polymorphs or derivatives thereof.

In an embodiment of the present invention, the stable agrochemical composition comprises: (a) boscalid or salts, esters, isomers, polymorphs or derivatives thereof; (b) azoxystrobin; (c) linear (C₈-C₁₅) alcohol derivative; and (d) styrene acrylic acid copolymer wherein said composition is in the form of water dispersible granules.

In an embodiment of the present invention, the stable agrochemical composition comprises: (a) boscalid or salts, esters, isomers, polymorphs or derivatives thereof; (b) tebuconazole; (c) linear (C₈-C₁₅) alcohol derivative; and (d) styrene acrylic acid copolymer wherein said composition is in the form of water dispersible granules.

In an embodiment of the present invention, the stable agrochemical composition comprises: (a) boscalid or salts, esters, isomers, polymorphs or derivatives thereof; (b) prothioconazole; (c) linear (C₈-C₁₅) alcohol derivative; and (d) styrene acrylic acid copolymer wherein said composition is in the form of water dispersible granules.

In an embodiment, the present invention provides stable water dispersible granules (WDG) formulation comprising (a) boscalid or salts, esters, isomers, polymorphs or derivatives thereof; (b) an additional fungicide; (c) a linear alcohol derivative; and (d) a polymeric dispersant.

In an embodiment of the present invention, the stable agrochemical composition comprises boscalid or salts, esters, isomers, polymorphs or derivatives thereof, prothioconazole, linear alcohol derivative and styrene acrylic acid co-polymer wherein the ratio of linear alcohol derivative and a styrene acrylic acid co-polymer is from about 0.5:1 to about 0.5:3.

According to an embodiment of the present invention, the stable agrochemical composition comprises
(i) about 0.1% w/w to about 80% w/w boscalid or salts, esters, isomers, polymorphs or derivatives thereof,
(ii) about 0.1% w/w to about 80% w/w of additional fungicide,
(iii) about 0.5% w/w to about 20% w/w linear alcohol derivative and
(iv) about 0.5% w/w to about 20% w/w styrene acrylic acid co-polymer.

The stable agrochemical composition can further comprise formulation excipients or agrochemically acceptable excipients.

In an embodiment the present water dispersible granule (WG) formulation comprises Boscalid in an amount in the range from 30 to 40% w/w and Prothioconazole in an amount in the range from 20 to 30% w/w of the total composition.

In an embodiment the present water dispersible granule (WG) formulation comprises Boscalid in an amount in the range from 30 to 40% w/w and azoxystrobin in an amount in the range from 20 to 30% w/w of the total composition.

According to an embodiment of the present invention, the stable agrochemical composition comprises
(i) about 1% w/w to about 80% w/w boscalid or salts, esters, isomers, polymorphs or derivatives thereof,
(ii) about 1% w/w to about 80% w/w prothioconazole,
(iii) about 0.5% w/w to about 20% w/w linear alcohol derivative and
(iv) about 0.5% w/w to about 20% w/w styrene acrylic acid co-polymer.

In an embodiment the linear alcohol derivative and a styrene acrylic acid co-polymer are present in a ratio from about 0.5:1 to about 0.5:3.

In an embodiment, the composition comprises boscalid and prothioconazole wherein the ratio between boscalid and prothioconazole is 35:20.

According to an embodiment of the present invention, the stable agrochemical composition comprises
(i) about 1% w/w to about 50% w/w boscalid,
(ii) about 1% w/w to about 50% w/w prothioconazole,
(iii) about 0.5% w/w to about 20% w/w linear alcohol derivative
(iv) about 0.5% w/w to about 20% w/w styrene acrylic acid co-polymer and
(v) an agrochemically acceptable excipient.

In an embodiment the stable agrochemical composition comprises boscalid, tebuconazole, linear alcohol derivative and styrene acrylic acid co-polymer wherein said linear alcohol derivative and a styrene acrylic acid co-polymer are in a ratio from about 0.5:1 to about 0.5:3.

In an embodiment the stable agrochemical composition comprises
(i) about 1% w/w to about 50% w/w boscalid,
(ii) about 1% w/w to about 50% w/w tebuconazole,
(iii) about 0.5% w/w to about 20% w/w linear alcohol derivative and
(iv) about 0.5% w/w to about 20% w/w styrene acrylic acid co-polymer
   wherein said linear alcohol derivative and a styrene acrylic acid co-polymer are in a ratio from about 0.5:1 to about 0.5:3.

In an embodiment of the present invention, the stable agrochemical composition comprises boscalid, azoxystrobin, linear alcohol derivative and styrene acrylic acid co-polymer.

In an embodiment the stable agrochemical composition comprises
(i) about 1% w/w to about 80% w/w boscalid,
(ii) about 1% w/w to about 80% w/w azoxystrobin,
(iii) about 0.5% w/w to about 20% w/w linear alcohol derivative
(iv) about 0.5% w/w to about 20% w/w styrene acrylic acid co-polymer
   wherein said linear alcohol derivative and a styrene acrylic acid co-polymer are in a ratio from about 0.5:1 to about 0.5:3.

In an embodiment of the present invention, the stable agrochemical composition comprises
(i) about 1% w/w to about 50% w/w boscalid,
(ii) about 1% w/w to about 50% w/w azoxystrobin,
(iii) about 0.5% w/w to about 20% w/w linear alcohol derivative
(iv) about 0.5% w/w to about 20% w/w styrene acrylic acid co-polymer and
(v) at least one agrochemically acceptable excipient.

In an embodiment, the composition comprises boscalid or salts, esters, isomers, polymorphs or derivatives thereof and azoxystrobin wherein the ratio between boscalid and azoxystrobin is 35:25.

In an embodiment of the present invention, the stable agrochemical composition comprising: (a) at least one SDHI fungicide; (b) at least one more additional fungicide; and (c) a linear (C₈-C₁₅) alcohol derivative; and (d) styrene acrylic acid co-polymer found non-phytotoxic on rice crop.

In an embodiment of the present invention, the stable agrochemical composition comprising: (a) boscalid; (b) prothioconazole; (c) linear (C₈-C₁₅) alcohol derivative; and (d) styrene acrylic acid co-polymer was found non-phytotoxic on rice crop.

In an embodiment of the present invention, the stable agrochemical composition comprising: (a) boscalid; (b) tebuconazole; (c) linear (C₈-C₁₅) alcohol derivative; and (d) styrene acrylic acid co-polymer was found non-phytotoxic on rice crop.

In an embodiment of the present invention, the stable agrochemical composition comprising: (a) boscalid; (b) azoxystrobin; (c) linear (C₈-C₁₅) alcohol derivative; and (d) styrene acrylic acid co-polymer was found non-phytotoxic on rice crop.

In an aspect of the present invention, there is provided a process of preparing the present stable agrochemical compositions.

In an embodiment, the process for preparation of stable agrochemical composition comprising steps of:
(i) mixing SDHI fungicide, an additional fungicide, linear alcohol derivative and polymeric dispersant and optionally with other agrochemically acceptable excipients to obtain homogeneous mixture; (ii) processing the homogeneous mixture of step (i) by suitable means.

In an embodiment of the present invention, the process of preparing stable agrochemical composition comprises;
(i) mixing SDHI fungicide, another fungicide, linear alcohol derivative and polymeric dispersant and optionally with other agrochemically acceptable excipients to obtain homogeneous mixture; (ii) processing the homogeneous mixture of step (i) by grinding to obtain wettable powder (WP) composition.

In an embodiment of the present invention, the process of preparing stable agrochemical composition comprises
(i) mixing succinate dehydrogenase inhibitor (SDHI) fungicide, an additional fungicide, linear alcohol derivative and polymeric dispersant and optionally other excipients to obtain homogeneous mixture; (ii) granulating the homogeneous mixture of step (i) by suitable means to obtain granules.

In an embodiment the process of preparing the stable agrochemical composition comprising:
(i) mixing SDHI fungicide, an additional fungicide, linear (C₈-C₁₅) alcohol derivative and styrene acrylic acid co-polymer and optionally other excipients to obtain homogeneous mixture and
(ii) granulating the homogeneous mixture of step (i) by suitable means.

In an embodiment of the present invention, there is provided a process of preparing stable agrochemical composition comprising the steps of:
(i) mixing boscalid, prothioconazole, linear C₁₂ alcohol derivative and styrene acrylic acid co-polymer and optionally other excipients to obtain homogeneous mixture and
(ii) granulating the homogeneous mixture of step (i) by suitable means.

In an embodiment of the present invention, there is provided a process of preparing stable agrochemical composition comprising the steps of:
(i) mixing boscalid, tebuconazole, linear C₁₂ alcohol derivative and styrene acrylic acid co-polymer and optionally other excipients to obtain homogeneous mixture and
(ii) granulating the homogeneous mixture of step (i) by suitable means.
(iii) In an embodiment of the present invention, there is provided a process of preparing stable agrochemical composition comprising the steps of:
(i) mixing boscalid, azoxystrobin, linear C₁₂ alcohol derivative and styrene acrylic acid co-polymer and optionally other excipients to obtain homogeneous mixture and
(ii) granulating the homogeneous mixture of step (i) by suitable means.

In an embodiment of the present invention, the process of preparing stable agrochemical composition comprising: (a) at least one SDHI fungicide; (b) at least one more fungicide; and (c) a linear (C₈-C₁₅) alcohol derivative; and (d) a styrene acrylic acid co-polymer wherein the composition is in the form of WDG.

In an embodiment of the present invention, the granulation is performed by pan granulation, spray drying or extrusion.

The inventive fungicidal combinations or compositions can be used for curative or protective/preventive control of phytopathogenic fungi. The invention therefore also relates to curative and protective methods for controlling phytopathogenic fungi by the use of the inventive active ingredients or compositions, which are applied to the seed, the plant or plant parts, the fruit or the soil in which the plants grow.

The compositions of the present disclosure maybe applied simultaneously as a tank mix formulation or a ready formulation or pre-mix formulation or may be applied sequentially. The application may be made as a foliar spray at different timings during crop development.

In an embodiment of the present invention, the present combinations/compositions are capable of preventing or curing, or both, disease caused by fungi.

Accordingly, there is provided a method of controlling phytopathogenic diseases by applying to the plants or to their locus, the stable agrochemical composition comprising: a fungicidal mixture of (a) at least one SDHI fungicide; (b) an additional fungicide; and (c) a linear (C₈-C₁₅) alcohol derivative; and (d) a polymeric dispersant.

In an embodiment of the present invention, there is provided a method of controlling phytopathogenic diseases by applying to the plants or to their locus, the stable agrochemical composition comprising: (a) at least one SDHI fungicide; (b) an additional fungicide; and (c) a linear (C₈-C₁₅) alcohol derivative; and (d) a styrene acrylic acid co-polymer.

In an embodiment of the present invention, there is provided a method of controlling phytopathogenic diseases by applying to the plants or to their locus, the stable agrochemical composition comprising: (a) boscalid; (b) an additional fungicide; (c) a linear (C₈-C₁₅) alcohol derivative; and (d) a styrene acrylic acid co-polymer.

In an embodiment of the present invention, there is provided a method of controlling phytopathogenic disease by applying to the plants or to their locus, the stable agrochemical composition comprising: (a) boscalid; (b) prothioconazole; (c) a linear (C₈-C₁₅) alcohol derivative; and (d) a styrene acrylic acid co-polymer.

In an embodiment of the present invention, there is provided a method of controlling phytopathogenic disease by applying to the plants or to their locus, the stable agrochemical composition comprising: (a) boscalid; (b) azoxystrobin; and (c) a linear (C₈-C₁₅) alcohol derivative; and (d) a styrene acrylic acid co-polymer.

In an embodiment of the present invention, there is provided a method of controlling phytopathogenic disease by applying to the plants or to their locus, the stable agrochemical composition comprising: (a) boscalid; (b) tebuconazole; and (c) a linear (C₈-C₁₅) alcohol derivative; and (d) a styrene acrylic acid co-polymer.

In an embodiment of the present invention, the stable agrochemical composition is used as a fungicide.

According to an embodiment of the present invention, the stable agrochemical composition is used to defend several varieties of fruits, vegetables, nuts and field crops against a wide spectrum of fungal infestations, including potato blight, tomato blight, leaf spot, scab (on apples and pears), and rust (on roses). It may also be used for removal of fungicidal infection of cotton, potatoes, corn, soybean, rice, safflower, sorghum, peanuts, tomatoes, flax, chilly, groundnut, cluster bean (Guar), pulses, cucurbits, cereals, ornamental plants including rose and marigold, fruits including apple and spices including cumin.

In an embodiment the present fungicidal mixtures/combinations/compositions are used for control of phytopathogenic fungi in rice crop.

In an embodiment the present invention provides a method for controlling sheath blight disease caused by Rhizoctonia solani in rice using present compositions comprising boscalid and a conazole fungicide. In an embodiment the conazole fungicide is prothioconazole.

In an embodiment the present invention provides a method for controlling blast disease caused by Pyricularia oryzae in rice using present compositions comprising boscalid and a conazole fungicide. In an embodiment the conazole fungicide is prothioconazole.

In an embodiment the present combinations/compositions are used for control of phytopathogenic fungi in potato crop.

In an embodiment the present invention provides a method for controlling early blight (Alternaria solani) disease of Potato using present compositions comprising boscalid and a strobilurin. In an embodiment the strobilurin is azoxystrobin.

In an embodiment the present combinations/compositions are used for control of phytopathogenic fungi in cumin crop.

In an embodiment the present invention provides a method for controlling powdery mildew (Erysiphe polygoni) disease in cumin using present compositions comprising boscalid and a strobilurin. In an embodiment the strobilurin is azoxystrobin.

In an embodiment the present composition comprising boscalid and an additional fungicide selected from the group of dithiocarbamate, conazole, benzimidazole, strobilurin and copper or derivatives thereof, is applied at an application of 100 to 1000 g/ha. In an embodiment the present composition is applied at an application rate of 100 to 600 g/ha. In an embodiment the present composition is applied at an application rate of 100 to 500 g/ha.

In an embodiment of the present invention, the stable agrochemical composition exhibits a broad range of fungicide activity against a large number of target pathogens. Non-limiting examples of specific pathogens targeted by the fungicide composition include: Botrytis cinerea (i.e., Botrytis bunch rot, gray mold, Botrytis blight), Phomopsis viticola (i.e., Phomopsis cane and leaf spot), Phomopsis rachis, Phomopsis vaccinii (i.e., Phomopsis twigblight and canker), downy mildew, Sphaerotheca macularis (i.e., powdery mildew), Guignardia bidwellii (i.e., black rot), Monilinia vacinii-cormbosi (i.e., mummy berry), Phragmidium sp. (i.e., yellow rust), Drepanopeziza sp. (i.e., anthracnose), Kuehneola sp. (i.e., cane and leaf rust), Sphaerulina sp. (i.e., orange rust), Arthuriomyces sp. (i.e., powder mildew), Mycosphaerella sp. (leaf spot), Colletotrichum acutatum (i.e., anthracnose fruit rot), Verticillium albo-atrum (i.e., Verticillium wilt), Phytophthora fragariae (i.e., red stele root rot), Dendrophoma obscurans (i.e., stem end rot, leaf blight), Phytophthora cactorum (i.e., leather rot), Diplocarpon earliana (i.e., leaf scorch), Godronia cassandrac (i.e., Fusicoccum canker), Alternaria sp. (i.e., Alternaria fruit rot), Exobasidium vaccinii (i.e., red leaf disease), Microsphaera vaccinii (i.e., powdery mildew), Venturia inaegualis (i.e., apple scab), Gymnosporangium sp. (i.e., apple rust), Podosphaera leucotricha (i.e., apple powdery mildew), black rot of apple, blossom end rot of apple, blue mold of apple, brown rot of stone fruit, Rhizopus sp., Leucostoma cincta or Leucostoma persoonii (i.e., Cytospora canker of stone fruits), white rot of apple, Monilinia fructicola (i.e., brown rot of stone fruit), Blumeriella jaapii (i.e., cherry leaf spot of stone fruit), sooty mold of pear, pear leafspot, pear leaf blight and fruit spot, Pythium ultimatum, Phytophthora infestans (late blight, potatoes), Aspergillus sp. (i.e., Aspergillus paraciticus), Apiosporina morbosa (i.e., black knot of stone fruit), Rhizoctonia solani (i.e., black scurf in potatoes, aerial blight, soybeans), Alternaria solani (early blight, potatoes), Sclerotium rolfsii (i.e., Sclerotium rot, sugar beets), powdery mildew (Erysiphe polygoni) in cumin, Fusarium sp., Septoria sp. and white mold in soybeans and the like.

In an embodiment of the present invention, the stable agrochemical composition can be used to combat a wide range of rice diseases. For example, it can be used to combat diseases, for example rice blast caused by the fungus Magnaporthae grisea (also known as Pyricularia grisea and formerly as Pyricularia oryzae), brown spot caused by the fungus Cochiobolus miyabeanus (also known as Bipolails oryzae and formerly as Helminthosporium oryzae), sheath blight caused by the fungus Thanatephorus cucumeris (also known as Rhizoctonia solan)), sheath blotch caused by the fungus Pyrenochaeta oryzae, black sheath rot caused by the fungus Gaeumannomyces graminis var. graminis and stem rot caused by the fungus Sclerotium oryzae (Magnaporthe salvinii).

In an embodiment, the present invention provides a synergistic composition that not only controls the fungal growth, but also helps in enhancing the biomass and in turn enhances the productivity and crop yield.

In an embodiment, the present invention provides synergistic combination which demonstrates a superadditive complementation of fungal control with increased crop production, by increasing root length over the application of individual active ingredients separately.

According to an embodiment of the present invention, a kit comprising stable agrochemical composition is provided. The kit comprises a plurality of components, each of which components may include at least one or more of the ingredients of the stable agrochemical composition of the present invention.

According to an embodiment of the present invention, a kit comprises:
(i) at least one succinate dehydrogenase inhibitor fungicide;
(ii) an additional fungicide;
(iii) a linear alcohol derivative; and
(iv) a polymeric dispersant.

According to an embodiment of the present invention, a kit comprises:
(i) boscalid;
(ii) an additional fungicide;
(iii) a linear alcohol derivative; and
(iv) a polymeric dispersant.

In one embodiment of the present invention, the kits may include one or more, including all, components that may be used to prepare the stable agrochemical composition. One or more of the components may already be combined or pre-formulated. In those embodiments where more than two components are provided in a kit, the components may already be combined and as such are packaged in a single container such as a vial, bottle, can, pouch, bag or canister.

It will be understood that the specification and examples are illustrative but not limitative of the present invention and that other embodiments within the spirit and scope of the invention will suggest themselves to those skilled in the art. Other embodiments can be practiced that are also within the scope of the present invention. The following examples illustrate the invention, but by no means intend to limit the scope of the claims.

### EXAMPLES

### Example 1: Boscalid 350+Prothioconazole 200 g/Kg WDG

| Ingredients | Amount (% w/w) |
|---|---|
| Boscalid | 35.92 |
| Prothioconazole | 20.61 |
| Linear (C₁₂) alcohol derivative | 03 |
| Styrene acrylic acid co-polymer | 3.5 |
| Ethylenediaminetetraacetic acid (EDTA) | 1 |
| disodium | |
| Kaolin | q.s. |
| Total | 100 |

35.92 g boscalid, 20.61 g prothioconazole, 3 g linear (C₁₂) alcohol derivative, 3.5 g styrene acrylic acid co-polymer, 1 g EDTA disodium and kaolin were mixed in air jet mill for about 30 min to obtain homogeneous mixture of desired particle size. Water was added to the homogeneous mixture to obtain dough. The dough was taken in a granulator for extrusion. The extruded granules were dried using fluidized bed dryer at 50-70° C. to obtain water dispersible granules.

### Example 2: Boscalid 400+Fluoxastrobin 200 g/Kg WDG

| Ingredients | Amount (% w/w) |
|---|---|
| Boscalid | 41.33 |
| Fluoxastrobin | 21.03 |
| Linear (C₁₂) alcohol derivative | 2 |
| Styrene acrylic acid co-polymer | 3.5 |
| EDTA disodium | 0.5 |
| Kaolin | q.s. |
| Total | 100 |

Boscalid, fluoxastrobin, linear (C₁₂) alcohol derivative, styrene acrylic acid co-polymer, EDTA disodium and kaolin were mixed in above quantity and granules were obtained according to the process described in the Example-1.

### Example 3: Boscalid 350+Azoxystrobin 250 g/kg WDG

| Ingredients | Amount (% w/w) |
|---|---|
| Boscalid | 36.22 |
| Azoxystrobin | 26.29 |
| Linear (C₁₂) alcohol derivative | 3 |
| Styrene acrylic acid co-polymer | 3.5 |
| EDTA disodium | 0.5 |
| Kaolin | 19.99 |
| Total | 100 |

Boscalid, azoxystrobin, linear (C₁₂) alcohol derivative, styrene acrylic acid co-polymer, EDTA disodium and kaolin were mixed in above quantity and granules were obtained according to the process described in the Example-1.

### Example 4: Boscalid 350 g/Kg+Prothioconazole 200 g/kg Powder

| Ingredients | Amount (% w/w) |
|---|---|
| Boscalid | 35.92 |
| Prothioconazole | 20.61 |
| Linear (C₁₂) alcohol derivative | 3 |
| Styrene acrylic acid co-polymer | 3.5 |
| EDTA disodium | 1 |
| Kaolin | q.s. |
| Total | 100 |

35.92 g Boscalid, 20.61 g prothioconazole, 3 g linear (C₁₂) alcohol derivative, 3.5 g styrene acrylic acid co-polymer and EDTA disodium and kaolin were taken in a vessel and blended to obtain mixture. The mixture was then taken for grinding in an air jet mill. The milled mixture was allowed for post blending to obtain powder composition.

### Example 5: Boscalid 350 g/Kg+Prothioconazole 200 g/Kg WDG (Comparative Example

| Ingredients | Amount (% w/w) |
|---|---|
| Boscalid | 35.92 |
| Prothioconazole | 20.61 |
| Styrene acrylic acid co-polymer | 3.5 |
| EDTA disodium | 1 |
| Kaolin | q.s. |
| Total | 100 |

Boscalid, prothioconazole, styrene acrylic acid co-polymer, EDTA disodium and kaolin were mixed in above quantity and granules were obtained according to the process described in the Example-1.

### Example 6: Boscalid 350 g/Kg+Prothioconazole 200 g/Kg WDG (Comparative Example

| Ingredients | Amount (% w/w) |
|---|---|
| Boscalid | 35.92 |
| Prothioconazole | 20.61 |
| Linear (C₁₂) alcohol derivative | 3 |
| EDTA disodium | 1 |
| Kaolin | q.s. |
| Total | 100 |

### Example 7

| Ingredients | Amount (% w/w) |
|---|---|
| Azoxystrobin | 25.0 |
| Boscalid | 35.0 |
| Sodium Ligno sulphonate | 10.0 |
| Linear Alcohol Derivative | 3.0 |
| Polymer | 3.5 |
| Ethylene diamine tetra acetic | 0.5 |
| acid, sodium salt | |
| Ammonium sulphate | 0.5 |
| Hydrous alumino- silicate. | Q.S. |
| Total | 100 |

### Example 8

Boscalid 350+Prothioconazole 200 g/Kg WDG

| Ingredients | Amount (% w/w) |
|---|---|
| Boscalid | 30-40 |
| Prothioconazole | 20-30 |
| Sodium Ligno sulphonate | 5-10 |
| Linear Alcohol Derivative | 3-5 |
| Styrene acrylic acid co-polymer | 3-7 |
| EDTA disodium | 1-2 |
| Ammonium Sulphate | 1-2 |
| Kaolin | Q.S. |
| Total | 100 |

### Example 9

Boscalid 350+Azoxystrobin 250 g/kg WDG

| Ingredients | Amount (% w/w) |
|---|---|
| Azoxystrobin | 20-30 |
| Boscalid | 30-40 |
| Sodium Ligno sulphonate | 5-10 |
| Linear Alcohol Derivative | 3-5 |
| Styrene acrylic acid co-polymer | 3-7 |
| EDTA disodium | 1-2 |
| Ammonium Sulphate | 1-2 |
| Kaolin | QS |
| Total | 100 |

### Example 10

### Evaluation of Physiochemical Parameters:

### Active Ingredient Stability:

Compositions of Example-1, 2 and 3 were studied with respect to active ingredient stability in ambient as well as accelerated heat stability (AHS) testing conditions. Degradation of active ingredient was studied. It was found that boscalid remained quite stable in all the three compositions of Example 1, 2 and 3 with slight degradation within the acceptable limits. Similarly, prothioconazole in composition of Example-1, fluoxastrobin in composition of Example-2 and azoxystrobin in composition of Example-3 remained quite stable. (Table-1).

TABLE 1

| | | Active | Active | |
|---|---|---|---|---|
| Compo- | Active | content | content (14 | % Active |
| sitions | Ingredient | (Ambient) | days AHS) | degradation |
| Example-1 | Boscalid | 35.61 | 34.76 | 2.39 |
| | Prothioconazole | 20.14 | 20.02 | 0.60 |
| Example-2 | Boscalid | 41.59 | 41.19 | 0.96 |
| | Fluoxastrobin | 21.78 | 21.57 | 0.96 |
| Example-3 | Boscalid | 35.58 | 35.39 | 0.53 |
| | Azoxystrobin | 25.62 | 25.24 | 1.48 |

### Physical Parameters:

The composition of Examples 1, 2, 3 and 4 evaluated for various physicochemical parameters. Suspensibility of the compositions of the present invention was calculated as per CIPAC MT 184. It was found that presence of linear (C₁₂) alcohol derivative and styrene acrylic acid co-polymer in the water dispersible granules of boscalid in combination resulted into better suspensibility. As evident from Table-1, compositions of Example-1, 2, 3 and 4 developed using linear (C₁₂) alcohol derivative and styrene acrylic acid co-polymer resulted into >90% suspensibility.

Wetting time was assessed as per CIPAC MT 53 to check the wettability feature of the composition. All the four compositions exhibited good wettability as entire test composition was able to sink completely within the acceptable time limit. All the compositions resulted into very minimal wet sieve retention within acceptable limits. Contrastingly, compositions of Example 5 and Example 6 which do not contain both linear (C₈-C₁₅) alcohol derivative and a styrene acrylic acid co-polymer together according to the present invention failed in one or the other physico-chemical parameter such that it could not pass the quality check parameters and hence discarded from further consideration. Composition of Example-5 found to have satisfactory wet sieve retention and suspensibility but failed in the wetting as it took more than 2 minutes to wet. Similarly, composition of Example-6 found to have satisfactory wetting and wet sieve retention but failed drastically in suspensibility parameter. Therefore, it was found that presence of both linear (C₈-C₁₅) alcohol derivative and a styrene acrylic acid co-polymer is required to prepare stable composition of SDHI based fungicides. (Table 2).

TABLE 2

| | Wetting | Gravimetric | Wet sieve |
|---|---|---|---|
| Compositions | observation | Suspensibility (%) | retention |
| Example 1 | Good | 95.01 | 0.05 |
| Example 2 | Good | 97.30 | 0.05 |
| Example 3 | Good | 95.18 | 0.05 |
| Example 4 | Good | 92.06 | 0.55 |
| Example 5 | Worst (150 s) | 87.83 | 0.65 |
| Example 6 | Good | 24.28 | 0.4 |

### Example 11

### Efficacy and Phytotoxicity Studies

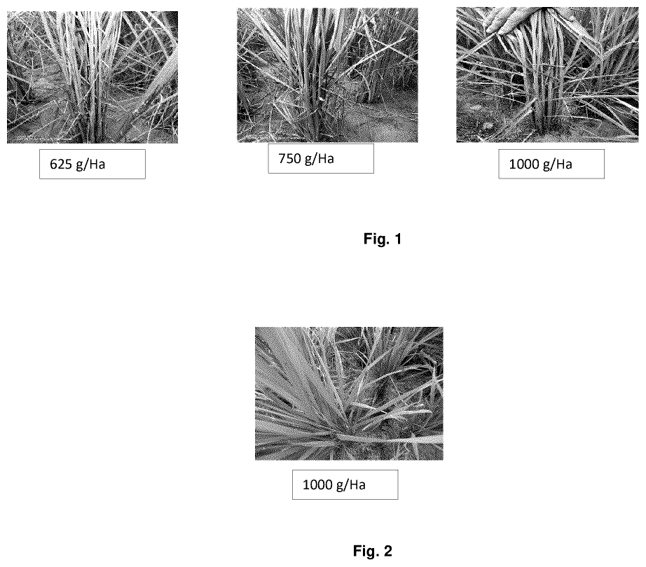

The composition of Example-1 was tested for efficacy on rice crop to control sheath blight disease caused by Rhizoctonia solani. Efficacy test was performed using three different dose rates viz. 625 g/Ha, 750 g/Ha and 1000 g/Ha. It was observed that the composition of Example-1 found be effective in controlling sheath blight disease at various dose rates. At 625 g/Ha, 61.90% control was observed, at 750 g/Ha around 70% control was observed and at 1000 g/Ha, around 80% control was observed. Furthermore, phytotoxicity study was also performed to assess the safety profile of the composition on rice crop. (FIG. 1) Observations were made in triplicate on 10^{th} day after treatment. At all the three dose rates, the composition of Exampel-1 found quite safe without any noticeable phytotoxicity observations. Therefore, the composition of Example-1 found to be quite effective in controlling sheath blight disease caused by Rhizoctania solani. (Table-3).

TABLE 3

| | | | Formulation | Percent | Phytotoxicity | | |
|---|---|---|---|---|---|---|---|
| | A.I. dose rate (g/Ha) | | dose rate | disease | 10 | 10 | 10 |
| Treatments | Boscalid | Prothioconazole | (ml or g/Ha) | control | DA-A | DA-B | DA-C |
| Example-1 | 218.8 | 125.0 | 625 | 61.90 | 0 | 0 | 0 |
| BD 35% + PTC | 262.5 | 150.0 | 750 | 70.65 | 0 | 0 | 0 |
| 20% | 350.0 | 200.0 | 1000 | 80.42 | 0 | 0 | 10 |

BD: Boscalid; PTC: Prothioconazole; 10 DA: 10^{th} day after treatment and A, B, C are replicates.

The composition of Example-1 was further tested for efficacy on rice crop to control blast disease caused by Pyricularia oryzae. Efficacy test was performed at 1000 g/ha dose rate. Observations were made on 7^{th} day after treatment. It was observed that the composition of Example-1 found be effective in controlling blast disease at 1000 g/ha as about 68% control of disease was observed. Furthermore, phytotoxicity study was also performed to assess the safety profile of the composition on rice crop. Observations were made in triplicate on 7^{th} day after treatment (as represented in FIG. 2). At 1000 g/ha dose rate, the composition of Exampel-1 found quite safe without any noticeable phytotoxicity observations. Therefore, the composition of Example-1 found to be effective in controlling blast disease caused by Pyricularia oryzae. (Table-4). Compositions of Example-5 and Example-6 were not considered for field testing as it failed in performance parameters during physico-chemical study.

TABLE 4

| | | | Formulation | Percent | | | |
|---|---|---|---|---|---|---|---|
| | A.I. dose rate | | dose rate | disease | | | |
| Treatments | (g/Ha) | | (ml or g/Ha) | control | Phytotoxicity | | |
| Example-1 | | | | | 7 DA-A | 7 DA-B | 7 DA-C |
| Boscalid 35% + | 350 | 200 | 1000 | 68.54 | 0 | 0 | 10 |

Prothioconazole
20%

7 DA: 7^{th} day after treatment and A, B, C are replicates.

It is evident from the above table that the present stable agrochemical compositions demonstrated excellent suspensibility and wettability upon dilution. The active ingredients found to remain quite stable after preparation and even during storage studies. Moreover, the stable agrochemical compositions found to be quite effective in controlling diseases of rice crop and simultaneously, does not show any phytotoxicity.

### Example 12

The present combination of fungicides was tested to evaluate the bioefficacy against Powdery Mildew disease in Cumin. The combination was applied as preventive application with an interval of 7 days at vegetative growth stage to target Powdery Mildew (Erysiphe sp., particularly Erysiphe polygoni). There was no phytotoxicity was recorded across the treatments in trial and bioefficacy is represented in below table.

TABLE 5

| | | Formulation | ERYSSP- Percent disease | | |
|---|---|---|---|---|---|
| Tr. | Treatment | Dose rate | control (PDC) | | |
| No. | details | (ml or g/ha) | 7 DA-B | 7 DA-C | 7 DA-D |
| 1 | Untreated check | — | 0 | 0 | 0 |
| 2 | Boscalid 35% + | 500 | 79.1 | 76 | 73.6 |
| | Azoxystrobin | | | | |
| | 25% WG | | | | |
| 3 | Boscalid 35% + | 600 | 82.3 | 78.9 | 75.4 |
| | Azoxystrobin | | | | |
| | 25% WG | | | | |

From the above table it is evident that the present combination showed good efficacy against powdery mildew disease of Cumin.

### Example 13

The present combination of fungicides was tested to evaluate bio efficacy against Early Blight (Alternaria solani) disease of Potato. The combination was applied as preventive application with an interval of 10 days at vegetative growth stage to target Potato Early Blight (Alternaria solani). There was no phytotoxicity was recorded across the treatments in trial.

TABLE 6

| | | Formulation | Alternaria solani | | | | | |
|---|---|---|---|---|---|---|---|---|
| Trt | | Dose rate | Percent disease control (PDC) | | | | | |
| No. | Treatment Name | (g/ml/ha) | 10 DA-A | | 10 DA-B | | 10 DA-C | |
| 1 | Untreated Check | | 0 | | 0 | | 0 | |
| 2 | Boscalid 35% + | 500 | 83 | abc | 78 | b | 75 | a |
| | Azoxystrobin 25% WG | | | | | | | |
| 3 | Boscalid 35% + | 600 | 86 | ab | 82 | b | 77 | a |
| | Azoxystrobin 25% WG | | | | | | | |

| | | | |
|---|---|---|---|
| LSD P = .05 | 5.4 | 2.5 | 2.9 |

* DA-A—Day of 1^{st} application, DA-B—Day of 2^{nd} application and DA-C—Day of 3rd application.

From the above table it is evident that the present combination showed good efficacy on early blight of Potato.

1. An agrochemical composition comprising:
(i) at least one succinate dehydrogenase inhibitor fungicide;
(ii) an additional fungicide;
(iii) a linear alcohol derivative; and
(iv) a polymeric dispersant.

2. The composition as claimed in claim 1, wherein the succinate dehydrogenase inhibitor fungicide is selected from the group consisting of flutolanil, boscalid, isofetamid, fluxapyroxad and penthiopyrad and a derivative thereof.

3. The composition as claimed in claim 1, wherein the composition comprises from about 0.1% w/w to about 80% w/w of the at least one succinate dehydrogenase inhibitor fungicide based on a total weight of the composition.

4. The composition as claimed in claim 1, wherein the additional fungicide is selected from the group consisting of dithiocarbamate, conazole, benzimidazole, strobilurin, copper group of fungicides, a derivative thereof and combinations thereof.

5. The composition as claimed in 1, wherein the additional fungicide is selected from the group consisting of cyproconazole, difenoconazole, epoxiconazole, etaconazole, hexaconazole, metconazole, propiconazole, prothioconazole, tebuconazole, tetraconazole, azoxystrobin, fluoxastrobin, picoxystrobin, pyraclostrobin, kresoxim-methyl, trifloxystrobin, a derivative and combinations thereof.

6. The composition as claimed in claim 1, wherein the composition comprises from about 0.1% w/w to about 80% w/w of the additional fungicide based on a total weight of the composition.

7. The composition as claimed in claim 1, wherein the linear alcohol derivative is selected from the group consisting of linear (C8-C15) alcohol derivatives.

8. The composition as claimed in claim 7, wherein the linear (C8-C15) alcohol derivative is selected from the group consisting of sodium 2-ethyl hexyl sulphate, sodium decyl sulphate, sodium octyl sulphates, sodium lauryl sulphate, potassium salt of dodecyl sulphate, and salts and derivatives thereof.

9. The composition as claimed in claim 1, wherein the composition comprises from about 0.5% w/w to about 20% w/w of the linear alcohol derivative based on a total weight of the composition.

10. The composition as claimed in claim 1, wherein the polymeric dispersant is selected from the group consisting of EO/PO block copolymers, styrene acrylic acid co-polymer, methacrylic copolymers, polyhydroxystearate derivatives and alkyl PEG resin derivatives.

11. The composition as claimed in claim 1, wherein the composition comprises from about 0.5% w/w to about 20% w/w of the polymeric dispersant based on a total weight of the composition.

12. The composition as claimed in claim 1 wherein the linear alcohol derivative and the polymeric dispersant consisting of styrene acrylic acid co-polymer are present in a ratio from about 0.5:1 to about 0.5:3.

13. The composition as claimed in claim 1, wherein the composition comprise water dispersible granules (WDG).

14. An agrochemical composition comprising boscalid, prothioconazole, a linear alcohol derivative and a styrene acrylic acid co-polymer, wherein said linear alcohol derivative and the styrene acrylic acid co-polymer are present in a ratio from about 0.5:1 to about 0.5:3.

15. An agrochemical composition comprising boscalid, tebuconazole, a linear alcohol derivative and a styrene acrylic acid co-polymer, wherein said linear alcohol derivative and the styrene acrylic acid co-polymer are present in a ratio from about 0.5:1 to about 0.5:3.

16. An agrochemical composition comprising boscalid, azoxystrobin, a linear alcohol derivative and a styrene acrylic acid co-polymer, wherein said linear alcohol derivative and the styrene acrylic acid co-polymer are present in a ratio from about 0.5:1 to about 0.5:3.

17. A process of preparing an agrochemical composition comprising: (a) at least one succinate dehydrogenase inhibitor fungicide; (b) an additional fungicide; c) a linear (C8-C15) alcohol derivative; and (d) a styrene acrylic acid co-polymer; wherein the process comprising steps of:
(i) mixing the succinate dehydrogenase inhibitor fungicide, the additional fungicide, the linear (C8-C15) alcohol derivative and the styrene acrylic acid co-polymer and optionally other agrochemically acceptable excipients to obtain a homogeneous mixture; and (ii) granulating the homogeneous mixture of step (i) to obtain granules.

18. The process as claimed in claim 17 wherein granulating the homogeneous mixture is through pan granulation, spray drying or extrusion.

19. A method of controlling phytopathogenic fungi by applying to a plant or to their locus, an agrochemical composition comprising: (a) at least one succinate dehydrogenase inhibitor fungicide; (b) one more fungicide; (c) a linear (C8-C15) alcohol derivative; and (d) a polymeric dispersant.

20. The method as claimed in claim 19, wherein the method comprises applying to plants or to their locus, the agrochemical composition comprising the succinate dehydrogenase inhibitor fungicide consisting of boscalid, the one more fungicide consisting of prothioconazole, the linear alcohol derivative and the polymeric dispersant consisting of a styrene acrylic acid co-polymer, wherein said linear alcohol derivative and the styrene acrylic acid co-polymer are in a ratio from about 0.5:1 to about 0.5:3.

21. The method as claimed in claim 19, wherein said method comprises applying to plants or to their locus, the agrochemical composition comprising the succinate dehydrogenase inhibitor fungicide consisting of boscalid, the one more fungicide consisting of tebuconazole, the linear alcohol derivative and the polymeric dispersant consisting of a styrene acrylic acid co-polymer, wherein said linear alcohol derivative and the styrene acrylic acid co-polymer are in a ratio from about 0.5:1 to about 0.5:3.

22. The method as claimed in claim 19, wherein the method comprises applying to plants or to their locus, the agrochemical composition comprising the succinate dehydrogenase inhibitor fungicide consisting of boscalid, the one more fungicide consisting of azoxystrobin, the linear alcohol derivative and the polymeric dispersant consisting of a styrene acrylic acid co-polymer, wherein said linear alcohol derivative and a styrene acrylic acid co-polymer are in a ratio from about 0.5:1 to about 0.5:3.

23. The composition as claimed in claim 1, wherein said agrochemical composition is stable in ambient and accelerated heat stability (AHS) storage conditions.
